(19) United States
(12) Patent Application Publication
(10) Pub. No.: US 2006/0182567 A1
(43) Pub. Date: Aug. 17, 2006

(54) Glass loading rack

(75) Inventor: Juan Roestel, Maturin (VE)

Correspondence Address: NIXON & VANDERHYE, PC, 901 NORTH GLEBE ROAD, 11TH FLOOR, ARLINGTON, VA, 22203, US

(73) Assignee: Guardian de Venezuela S.A.

(21) Appl. No.: 11/058,413

(22) Filed: Feb. 16, 2005

(51) Int. Cl. B60P 3/00

(52) U.S. Cl. 414/458

(57) ABSTRACT

A glass sheet support rack includes a frame including glass sheet support legs extending in opposite directions; at least two axially-spaced, substantially inverted U-shaped jack channels located at a lower end of the frame and along a longitudinal axis of the frame. A transporter for use with the support rack includes an elongated jack base supported on a plurality of wheels, the jack base mounting a plurality of actuators therein; a jack beam located on the jack base and connected to the actuators for moving the jack beam from a retracted position to an extended position; a motor for controlling the plurality of actuator; and a hitch for connecting the transporter to a powered vehicle.

### BACKGROUND OF THE INVENTION

This invention relates to apparatus for supporting and transporting glass sheets and the like and, more specifically, to a transporter for moving a glass sheet supporting rack into a shipping container, truck trailer or the like.

Securing large glass sheets on generally A-shaped frames for transport from a place of manufacture to an installation site is well known. Typically, the sheets are stacked on edge, on opposite sides of the frame, and at opposite acute angles to provide stability to both the glass sheets and the supporting frame. Oftentimes, transportation is by truck, but other modes, e.g., rail car, have also been employed. One example of apparatus used to transport large glass sheets is disclosed in U.S. Pat. No. 3,848,917 where an A-shaped frame rests on a conventional semi-trailer frame. Similar arrangements are also disclosed in U.S. Pat. Nos. 4,195,738 and 4,385,856. Another example may be found in U.S. Pat. No. 3,955,676 where a glass-support rack is comprised of a pair of A-frame sections that are collapsible when not in use. According to the '676 patent, the rack is secured in place on a flat bed or floor of a truck trailer or rail car before the glass sheets are loaded onto the rack.

### BRIEF DESCRIPTION OF THE INVENTION

This invention provides a novel transport device for moving a fully-loaded glass support rack onto the floor of a shipping container, such as a standard ISO shipping container, enclosed truck trailer, rail car or the like. It will be appreciated, however, that the transport device could also be used to move the glass-support rack onto any shipping platform.

In the exemplary embodiment, an otherwise conventional A-frame type glass-support rack is modified to include a pair of axially-spaced jack channels each having a generally inverted U-shape. The jack channels are located at the lower end of, and between the A-frame subassemblies of the rack, and are adapted to receive an elongated jack beam of a mobile transporter device. The transporter device also includes a hydraulic motor for extending and retracting multiple actuators mounted in the jack base for lifting the jack beam, along with a hitch for connecting the transporter to a forklift or other suitable drive vehicle. In the exemplary embodiment, the actuators are hydraulic piston and cylinder assemblies.

In use, the forklift will maneuver the transporter into alignment with the axially-spaced jack channels in the glasslsupport rack, and then push the transporter further so that the jack beam component thereof is located under the rack. The hydraulic cylinders will then be actuated to raise the jack beam into engagement with the jack channels and to raise the glass-support rack off the floor or other platform. The forklift is then able to push the transporter and rack onto the floor of a shipping container or onto a truck bed or the like. Once in place, the actuator pistons are retracted and the jack beam and rack lowered. Thereafter, the transporter device is withdrawn by the forklift.

Accordingly, in one aspect, the invention relates to a glass sheet support rack comprising a frame including glass sheet support legs extending in opposite directions; at least two axially-spaced, substantially inverted U-shaped jack channels located at a lower end of the frame, along a longitudinal axis of the frame, the jack channels defining an open channel along the frame adapted for engagement by an elongated jack beam.

In another aspect, the invention relates to a glass sheet support rack comprising a pair of generally A-frame subassemblies axially spaced from one another and connected by one or more crossbeams; each frame subassembly having oppositely extending support legs at lower ends thereof adapted to support a plurality of glass sheets; each frame subassembly further comprising a generally inverted U-shaped jack channel adapted to receive a longitudinal jack beam of an associated transporter.

In still another aspect, the invention relates to a mobile glass support rack transporter comprising an elongated jack base supported on a plurality of wheels, said jack base mounting a plurality of actuators therein; a jack beam located on the jack base and connected to the actuators for moving the jack beam from a retracted position to an extended position; a motor for controlling the plurality of actuator; and a hitch for connecting the transporter to a powered vehicle.

The invention will now be described in connection with the drawings identified below.

### BRIEF DESCRIPTION OF THE DRAWINGS

FIG. 1 is an interior end view of a glass-support rack, illustrating one of a pair of A-frame subassemblies in accordance with an exemplary embodiment of the invention;

FIG. 2 is a side elevation of the glass-support rack shown in FIG. 1;

FIG. 3 is an enlarged end view of one of a pair of jack beams in the glass-support rack shown in FIGS. 1 and 2;

FIG. 4 is a plan view of a lower crossbeam shown in FIG. 2;

FIG. 5 is a side elevation of a mobile transporter in accordance with the invention;

FIG. 6 is a plan view of the transporter shown in FIG. 4 but with the jack beam component removed; and

FIG. 7 is a side elevating the mobile transporter shown in FIG. 4, but with the jack beam extended to a lifting position, and showing in phantom, hydraulic lines between hydraulic lifting cylinders and a hydraulic motor on the mobile transporter.

### DETAILED DESCRIPTION OF THE INVENTION

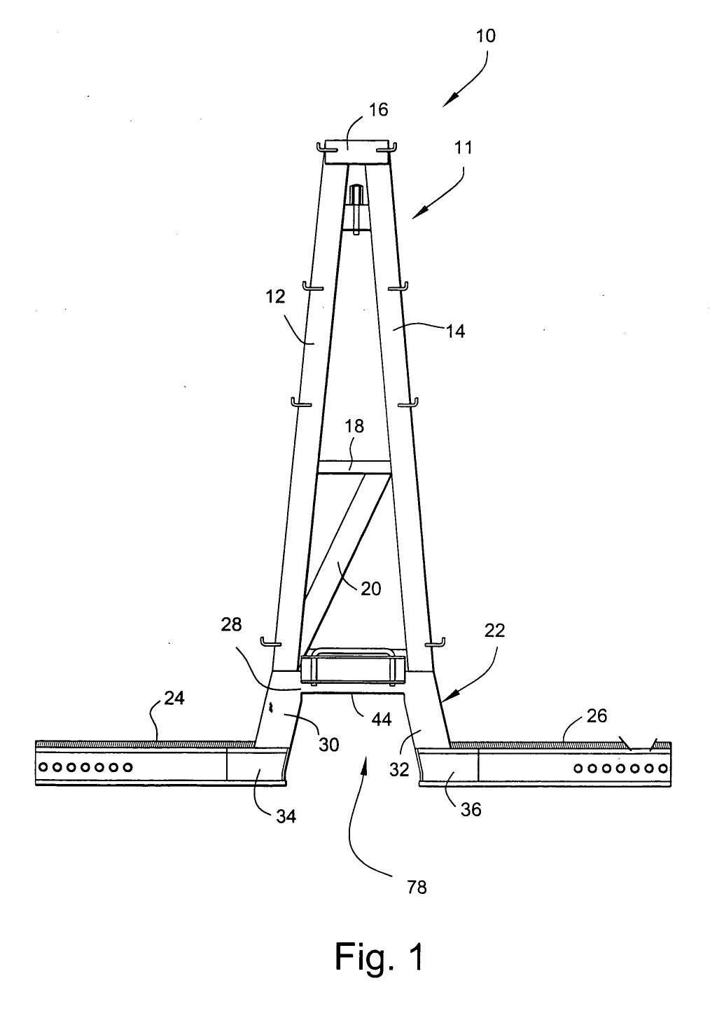

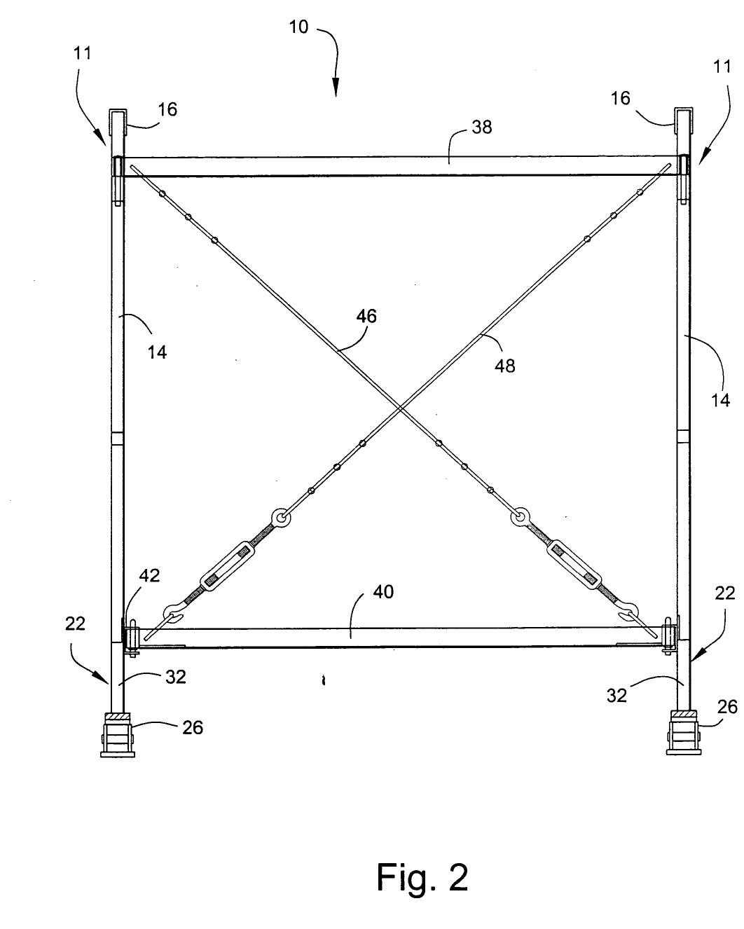

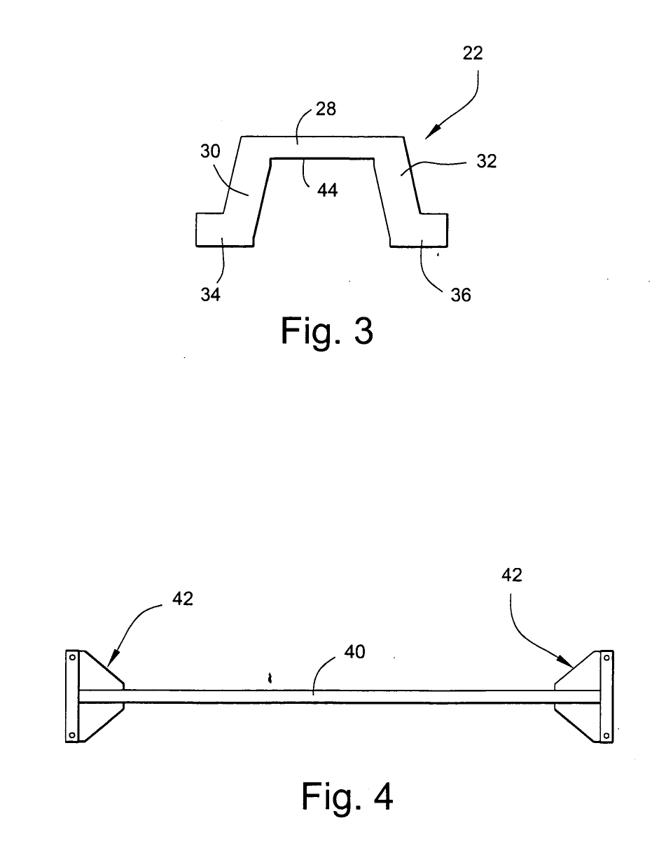

With reference initially to FIGS. 1-3, the glass support rack 10 is essentially a conventional rack modified to accommodate interaction with the mobile transporter described further below. The rack 10 has a generally A-shaped end profile as best seen in FIG. 1. Each end of the rack has an A-frame subassembly 11 that includes a pair of A-frame members 12 and 14 that are slanted at an acute angle to vertical such that members 12 and 14 are joined at the top of the rack by welding directly or via a cap plate 16. The A-frame members 12 and 14 diverge from top to bottom, and horizontal strut 18 and diagonal strut 20 are welded therebetween to provide the required rigidity to the rack. A jack channel 22, having a generally inverted U-shape, is interposed between the lower ends of each frame member 12 and 14, respectively, and glass support members (or horizontal stabilizers) 24, 26. More specifically, each jack channel 22 is defined by an upper cross piece 28, a pair of downwardly and outwardly slanted legs 30, 32, and oppositely extending horizontal flanges 34, 36 as best seen in FIG. 3. The latter are joined to the stabilizers 24, 26 by any suitable means, preferably welding. Similarly, the lower ends of frame members 12 and 14 are fixed by, e.g., welding, to the top of the jack channel 22 in substantial alignment with legs 30, 32 of the jack channel.

An identical A-frame assembly 11 is located at the opposite end of the rack, and the two assemblies are connected by an upper crossbeam 38 that is welded or otherwise suitably fixed to the upper ends of the A-frame assemblies. A lower crossbeam 40 extends between the lower ends of the A-frame assemblies and includes a pair of brackets 42 that are, in turn, secured to the cross pieces 28 of the jack channels 22. With this arrangement, the lower surfaces 44 (FIGS. 1 and 3) of the cross pieces 26 are free to be engaged by an elongated jack beam also described further below. Diagonal tension cables 46, 48 may be employed to further rigidify the A-frame assemblies at each end of the rack.

It will be appreciated that, in use, glass sheets are stacked, on edge, on the horizontal glass support members 24, 26 on each side of the rack, and secured in conventional fashion.

It will be understood that the incorporation of jack channels 22 is not limited to the specific glass support rack described in connection with the exemplary embodiment, and that the invention may be employed with other rack support configurations as well, with similar modifications.

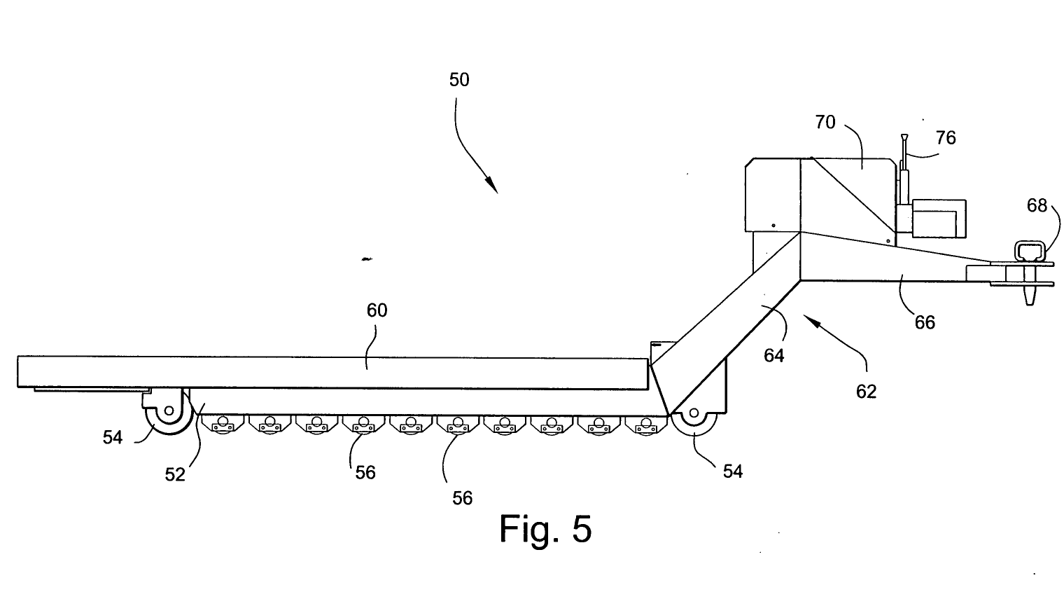

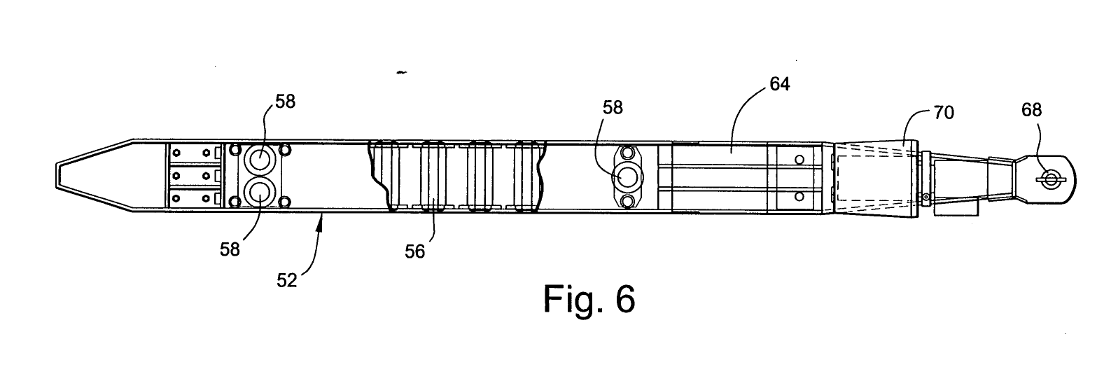

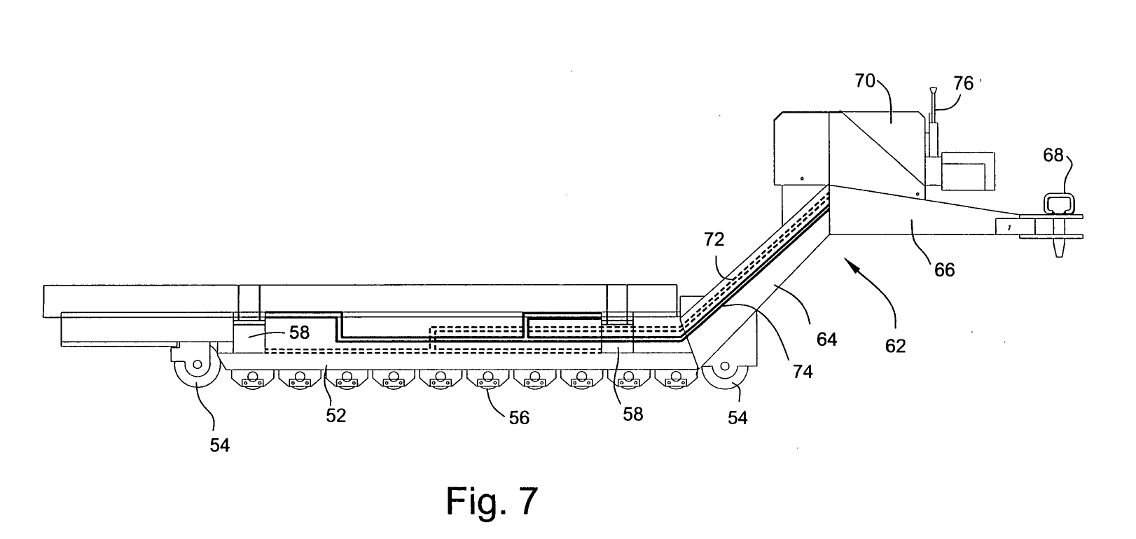

Turning now to FIGS. 5-7, a mobile transporter 50 includes an elongated base portion 52 supported on multiple rollers or wheels 54, 56 secured to the base 52 by any suitable means. The base portion 52 includes at least 2, and as many as 4, actuators 58 (three shown) that are arranged at forward and rearward locations along the base portion 52. These actuators are oriented so as to enable extension of an overlying jack beam 60 from the retracted position shown in FIG. 5 to the extended position shown in FIG. 7. In the exemplary embodiment, actuators 58 are hydraulic piston and cylinder assemblies. It will be appreciated, however, that other suitable actuators and controllers may be employed.

The jack beam 60 is configured generally similarly to the base portion 52 but slightly larger so that, in the retracted position, the jack beam 60 telescopes over the base portion 52 as shown in FIG. 5. A hitch assembly 62 is connected at the rearward end of the base portion and includes a first upwardly angled support beam 64 and a horizontal hitch beam 66 fitted with a conventional hitch device 68. Beams 64, 66 also support a hydraulic motor 70 that is operably connected to the hydraulic actuators 58 by “extend” and “retract” lines 72, 74, respectively. One or more control sticks (one shown) 76 enable the user to operate the actuators 58 from a safe location behind the transporter.

In use, the hitch 68 is connected to a drive vehicle, such as a forklift (not shown) and the transporter 50 is pushed toward the rack 10, so that the jack beam 60 is axially aligned with the opening 78 (FIG. 1) defined by the jack channels 20. The forklift continues to push the transporter into the opening 78 until the jack beam 604 is substantially centered beneath the jack channels 20. The operator then manipulates the control stick(s) 76 to extend the pistons of the hydraulic actuators 58, thereby extending the jack beam 60 to engage the surfaces 40 of the jack channels 20 and lift the support rack 10 off the floor. It is sufficient for purposes of this invention that the support be raised off the floor by a few inches or less. The forklift can then push the entire rack 10 and mobile transporter 50 into the shipping container (or onto a shipping bed or platform). The operator then retracts the hydraulic actuators 58, dropping the jack beam 60 to a lower position (FIG. 5), so that the glass-support rack is lowered onto the floor or bed of the shipping truck or the like. After separation is achieved between the beam 60 and the jack channels 20, the operator can then withdraw the mobile transporter 50 from the support rack, again with the utilization of the forklift or other vehicle.

Springs or other equivalent means may be employed to normally maintain the jack beam 60 in its retracted or lowered position.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A glass sheet support rack comprising a frame including glass sheet support legs extending in opposite directions; at least two axially-spaced, substantially inverted U-shaped jack channels located at a lower end of said frame, along a longitudinal axis of the frame, said jack channels defining an open channel along said frame adapted for engagement by an elongated jack beam.

2. The glass sheet support rack of claim 1 wherein at least one crossbeam extends axially between the jack channels.

3. The glass sheet support rack of claim 1 wherein said frame comprises a pair of A-frame subassemblies connected by one or more crossbeams.

4. The glass sheet support rack of claim 1 wherein each jack channel comprises an upper cross-piece, a pair of downwardly and outwardly slanted legs and oppositely extending horizontal flanges.

5. The glass sheet support rack of claim 4 wherein said oppositely extending horizontal flanges are connected to oppositely extending glass sheet support legs.

6. A glass sheet support rack comprising:
a pair of generally A-frame subassemblies axially spaced from one another and connected by one or more crossbeams; each frame subassembly having oppositely extending support legs at lower ends thereof adapted to support a plurality of glass sheets; each frame subassembly further comprising a generally inverted U-shaped jack channel adapted to receive a longitudinal jack beam of an associated transporter.

7. The glass sheet support rack of claim 6 wherein each jack channel is located at a lower end of the respective A-frame subassembly, and centrally located between said support legs.

8. The glass sheet support rack of claim 7 wherein a crossbeam extends axially between the jack channels.

9. The glass sheet support rack of claim 7 wherein each jack channel comprises an upper cross-piece, a pair of downwardly and outwardly slanted legs and oppositely extending horizontal flanges.

10. The glass sheet support rack of claim 9 wherein a lower surface of said upper cross-piece is adapted to be engaged by the jack beam of the associated transporter.

11. The glass sheet support rack of claim 6 in combination with a mobile transporter comprising an elongated jack base supported on a plurality of wheels, a jack beam supported on said jack base and at least one actuator in said jack base for moving said jack beam between retracted and extended positions.

12. The glass sheet support rack of claim 11 wherein said mobile transporter further comprises a motor for powering said at least one actuator.

13. The glass sheet support rack of claim 11 wherein said at least one actuator comprises a plurality of hydraulic piston and cylinder assemblies.

14. The glass sheet support rack of claim 12 wherein said motor comprises a hydraulic motor with extend and retract lines connected between said hydraulic motor and said at least one actuator.

15. The glass sheet support rack of claim 10 wherein said mobile transporter further comprises a hitch adapted to connect the mobile transporter to a powered vehicle.

16. A mobile glass support rack transporter comprising an elongated jack base supported on a plurality of wheels, said jack base mounting a plurality of actuators therein; a jack beam located on said jack base and connected to said actuators for moving said jack beam from a retracted position to an extended position; a motor for controlling said plurality of actuator; and a hitch for connecting said transporter to a powered vehicle.

17. The mobile glass support rack transporter of claim 16 wherein each of said plurality of actuators comprises a hydraulic piston and cylinder assembly.

18. The mobile glass support rack transporter of claim 17 wherein said motor is hydraulically connected to each of said hydraulic piston and cylinder assemblies.

19. The mobile glass support rack transporter of claim 16 wherein said hitch is supported on a hitch beam located above said jack base.
